(19) United States
(12) Patent Application Publication
(10) Pub. No.: US 2022/0070794 A1
(43) Pub. Date: Mar. 3, 2022

(54) METHOD FOR DETERMINING A MAXIMUM OUTPUT POWER AND UE THEREOF

(71) Applicant: LG ELECTRONICS INC., Seoul (KR)

(72) Inventors: Suhwan LIM, Seoul (KR); Seungwoo RYU, Seoul (KR); Jaehyun PARK, Seoul (KR); Sangwook LEE, Seoul (KR); Jongkeun PARK, Seoul (KR)

(21) Appl. No.: 17/419,451

(22) PCT Filed: Dec. 18, 2019
(86) PCT No.: PCT/KR2019/017976

§ 371 Date: Jun. 29, 2021

Related U.S. Application Data
(60) Provisional application No. 62/805,286, filed on Feb. 13, 2019.

(30) Foreign Application Priority Data
Mar. 29, 2019 (KR) 10-2019-0037354

(51) Int. Cl. H04W 52/36; H04W 52/14; H04B 1/3827

(52) U.S. Cl. CPC H04W 52/367; H04B 1/3838; H04W 52/146

(57) ABSTRACT

A disclosure of the present specification provides a method for determining a maximum output power. The method may be performed by a user equipment (UE) and comprise: transmitting capability information; and determining the maximum output power. Based on that the capability information does not includes a maximum uplink duty cycle, the maximum output power is determined by using a power management UE maximum power reduction (P-MPR).

### TECHNICAL FIELD

The present disclosure relates to mobile communication.

### BACKGROUND

With the success of Evolved Universal Terrestrial Radio Access Network (E-UTRAN) for the fourth-generation mobile communication which is Long Term Evolution (LTE)/LTE-Advanced (LTE-A), the next generation mobile communication, which is the fifth-generation (so called 5G) mobile communication, has been attracting attentions and more and more researches are being conducted.

For the fifth-generation (so called 5G) mobile communication, a new radio access technology (New RAT or NR) have been studied and researched.

An NR cell may operate not just in standalone deployment (SA), but also in a non-standalone deployment (NSA). According to the NSA deployment, a UE may be connected in dual connectivity (DC) with an E-UTRAN (that is, LTE/LTE-A) cell and the NR cell. This type of dual connectivity is called EN-DC.

High frequencies such as mmWave in FR2 band of Table 6 may conduct a human body.

In order to prevent the high frequencies such as mmWave from conducting the human body, a maximum permissible exposure (MPE) limitation is needed.

### SUMMARY

Accordingly, a disclosure of the present specification has been made in an effort to solve the aforementioned problem.

Accordingly, in an effort to solve the aforementioned problem, a disclosure of the present specification provides a method for determining a maximum output power. The method may be performed by a user equipment (UE) and comprise: transmitting capability information; and determining the maximum output power. Based on that the capability information does not includes a maximum uplink duty cycle, the maximum output power is determined by using a power management UE maximum power reduction (P-MPR).

The maximum uplink duty cycle may represent a maximum percentage of symbols used for uplink transmission during a given time period.

The P-MPR may be applied to satisfy a power exposure requirement.

The method may further comprise: transmitting information on the determined maximum output power.

The maximum uplink duty cycle may be defined for a frequency range (FR) 2.

The FR2 may include a n257 band, a n258 band, a n259 band a n260 band and a n261 band.

The method may further comprise: determining the maximum uplink duty cycle; and performing an uplink transmission based on the determined maximum uplink duty cycle.

Also, in an effort to solve the aforementioned problem, a disclosure of the present specification provides a user equipment (UE) for determining a maximum output power. The UE may comprise: a transceiver; and a processor configured to control the transceiver. The processor may transmit capability information and determines the maximum output power. Based on that the capability information does not includes a maximum uplink duty cycle, the maximum output power may be determined by using a power management UE maximum power reduction (P-MPR).

According to the disclosure of the present disclosure, the problem of the conventional technology described above may be solved.

### BRIEF DESCRIPTION OF THE DRAWINGS

FIG. 1 is a wireless communication system.

FIG. 2 illustrates a structure of a radio frame according to FDD in 3GPP LTE.

FIGS. 3A to 3C are diagrams illustrating exemplary architecture for a service of the next-generation mobile communication.

FIG. 4 illustrates an example of a subframe type in NR.

FIG. 5 illustrates an example of an SS block in NR.

FIG. 6 illustrates an example of beam sweeping in NR.

FIG. 7 illustrates an example of a method of limiting transmission power of a wireless device.

FIG. 8 shows an exemplary flow for transmitting capability information.

FIG. 9 shows an exemplary signal flows of the present disclosure.

FIG. 10 is a block diagram illustrating a wireless device and a base station, by which the disclosure of this specification can be implemented.

FIG. 11 is a detailed block diagram illustrating a transceiver of the wireless device.

FIG. 12 shows a wireless communication system according to an embodiment.

FIG. 13 is a block diagram of a network node according to an embodiment.

FIG. 14 is a block diagram showing a structure of a terminal according to an embodiment.

FIG. 15 shows an example of a 5G usage scenario.

FIG. 16 shows an AI system 1 according to an embodiment.

### DETAILED DESCRIPTION OF THE EMBODIMENTS

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present disclosure includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present disclosure, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

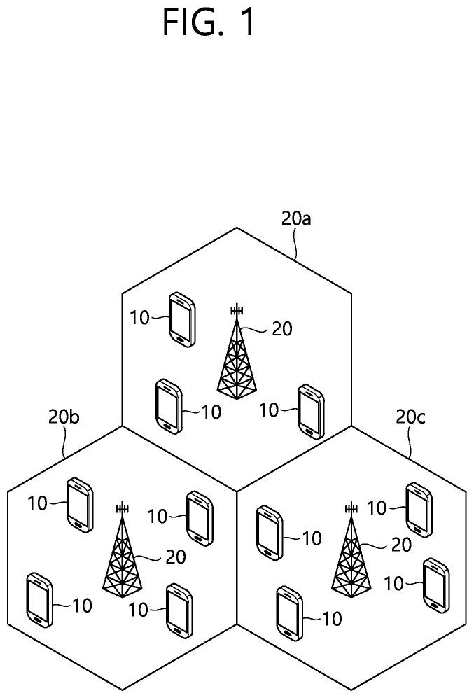

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE1 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

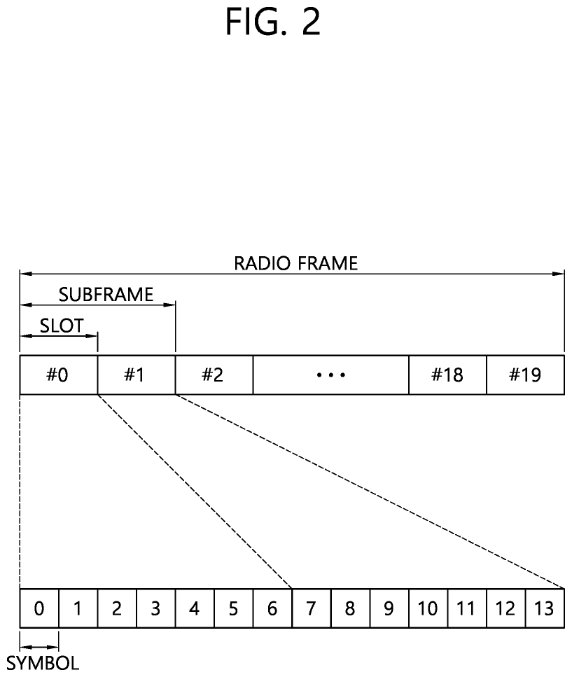

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

One slot includes N_{RB} resource blocks (RBs) in the frequency domain. For example, in the LTE system, the number of resource blocks (RBs), i.e., N_{RB}, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The uplink channels include a PUSCH, a PUCCH, an SRS (Sounding Reference Signal), and a PRACH (physical random access channel).

### Carrier Aggregation

A carrier aggregation system is now described.

A carrier aggregation system aggregates a plurality of component carriers (CCs). A meaning of an existing cell is changed according to the above carrier aggregation. According to the carrier aggregation, a cell may signify a combination of a downlink component carrier and an uplink component carrier or an independent downlink component carrier.

Further, the cell in the carrier aggregation may be classified into a primary cell, a secondary cell, and a serving cell. The primary cell signifies a cell operated in a primary frequency. The primary cell signifies a cell which UE performs an initial connection establishment procedure or a connection reestablishment procedure or a cell indicated as a primary cell in a handover procedure. The secondary cell signifies a cell operating in a secondary frequency. Once the RRC connection is established, the secondary cell is used to provided an additonal radio resouce.

As described above, the carrier aggregation system may support a plurality of component carriers (CCs), that is, a plurality of serving cells unlike a single carrier system.

The carrier aggregation system may support a cross-carrier scheduling. The cross-carrier scheduling is a scheduling method capable of performing resource allocation of a PDSCH transmitted through other component carrier through a PDCCH transmitted through a specific component carrier and/or resource allocation of a PUSCH transmitted through other component carrier different from a component carrier basically linked with the specific component carrier.

### Introduction of Dual Connectivity (DC)

Recently, a scheme for simultaneously connecting UE to different base stations, for example, a macro cell base station and a small cell base station, is being studied. This is called dual connectivity (DC).

In DC, the eNodeB for the primary cell (Pcell) may be referred to as a master eNodeB (hereinafter referred to as MeNB). In addition, the eNodeB only for the secondary cell (Scell) may be referred to as a secondary eNodeB (hereinafter referred to as SeNB).

A cell group including a primary cell (Pcell) implemented by MeNB may be referred to as a master cell group (MCG) or PUCCH cell group 1. A cell group including a secondary cell (Scell) implemented by the SeNB may be referred to as a secondary cell group (SCG) or PUCCH cell group 2.

Meanwhile, among the secondary cells in the secondary cell group (SCG), a secondary cell in which the UE can transmit Uplink Control Information (UCI), or the secondary cell in which the UE can transmit a PUCCH may be referred to as a super secondary cell (Super SCell) or a primary secondary cell (Primary Scell; PScell).

### Next-Generation Mobile Communication Network

With the success of Evolved Universal Terrestrial Radio Access Network (E-UTRAN) for the fourth-generation mobile communication which is Long Term Evolution (LTE)/LTE-Advanced (LTE-A), the next generation mobile communication, which is the fifth-generation (so called 5G) mobile communication, has been attracting attentions and more and more researches are being conducted.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

The ITU suggests three usage scenarios, for example, enhanced Mobile BroadBand (eMBB), massive Machine Type Communication (mMTC), and Ultra Reliable and Low Latency Communications (URLLC).

URLLC relates to a usage scenario in which high reliability and low delay time are required. For example, services like autonomous driving, automation, and virtual realities requires high reliability and low delay time (for example, 1 ms or less). A delay time of the current 4G (LTE) is statistically 21-43ms (best 10%), 33-75 ms (median). Thus, the current 4G (LTE) is not sufficient to support a service requiring a delay time of 1 ms or less. Next, eMBB relates to a usage scenario in which an enhanced mobile broadband is required.

That is, the fifth-generation mobile communication system aims to achieve a capacity higher than the current 4G LTE and is capable of increasing a density of mobile broadband users and support Device-to-Device (D2D), high stability, and Machine Type Communication (MTC). Researches on 5G aims to achieve reduced waiting time and less batter consumption, compared to a 4G mobile communication system, in order to implement the IoT. For the 5G mobile communication, a new radio access technology (New RAT or NR) may be proposed.

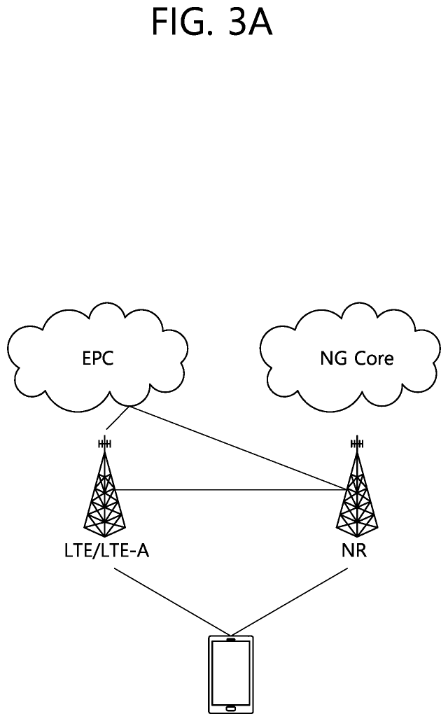

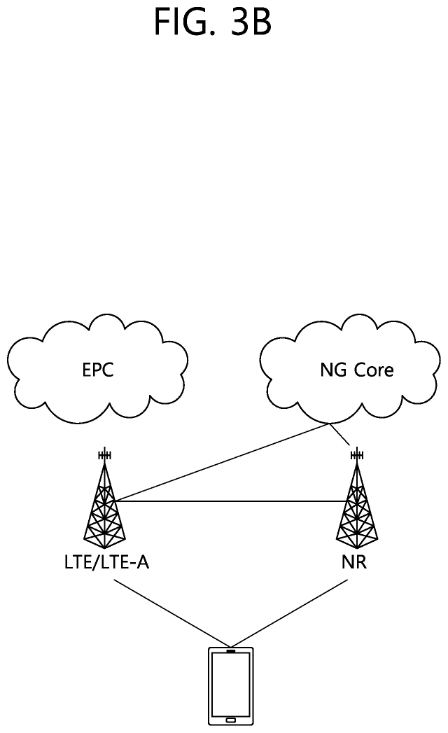

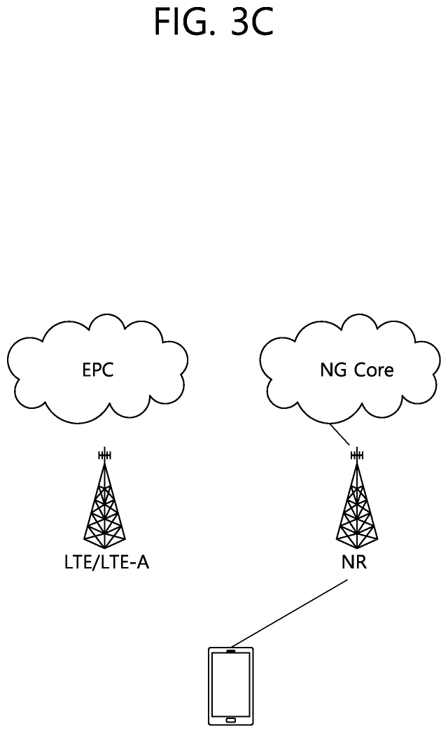

FIGS. 3A to 3C are diagrams illustrating exemplary architecture for a next-generation mobile communication service.

Referring to FIG. 3A, a UE is connected in dual connectivity (DC) with an LTE/LTE-A cell and a NR cell.

The NR cell is connected with a core network for the legacy fourth-generation mobile communication, that is, an Evolved Packet core (EPC).

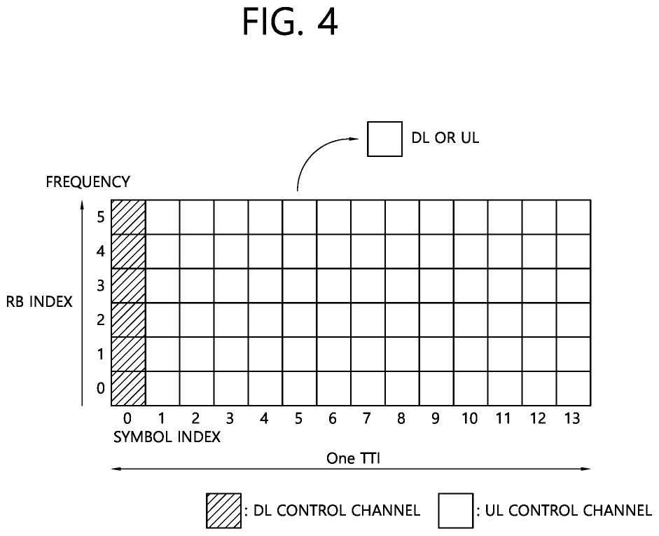

Referring to FIG. 3B, the LTE/LTE-A cell is connected with a core network for 5th generation mobile communication, that is, a Next Generation (NG) core network, unlike the example in FIG. 4A.

A service based on the architecture shown in FIGS. 3A and 3B is referred to as a non-standalone (NSA) service.

Referring to FIG. 3C, a UE is connected only with an NR cell. A service based on this architecture is referred to as a standalone (SA) service.

Meanwhile, in the above new radio access technology (NR), using a downlink subframe for reception from a base station and using an uplink subframe for transmission to the base station may be considered. This method may be applied to paired spectrums and not-paired spectrums. A pair of spectrum indicates including two subcarrier for downlink and uplink operations. For example, one subcarrier in one pair of spectrum may include a pair of a downlink band and an uplink band.

FIG. 4 shows an example of subframe type in NR.

A transmission time interval (TTI) shown in FIG. 4 may be called a subframe or slot for NR (or new RAT). The subframe (or slot) in FIG. 4 may be used in a TDD system of NR (or new RAT) to minimize data transmission delay. As shown in FIG. 4, a subframe (or slot) includes 14 symbols as does the current subframe. A front symbol of the subframe (or slot) may be used for a downlink control channel, and a rear symbol of the subframe (or slot) may be used for a uplink control channel. Other channels may be used for downlink data transmission or uplink data transmission. According to such structure of a subframe (or slot), downlink transmission and uplink transmission may be performed sequentially in one subframe (or slot). Therefore, a downlink data may be received in the subframe (or slot), and a uplink acknowledge response (ACK/NACK) may be transmitted in the subframe (or slot). A subframe (or slot) in this structure may be called a self-constrained subframe. If this structure of a subframe (or slot) is used, it may reduce time required to retransmit data regarding which a reception error occurred, and thus, a final data transmission waiting time may be minimized In such structure of the self-contained subframe (slot), a time gap may be required for transition from a transmission mode to a reception mode or vice versa. To this end, when downlink is transitioned to uplink in the subframe structure, some OFDM symbols may be set as a Guard Period (GP).

### Support of Various Numerologies

In the next generation system, with development of wireless communication technologies, a plurality of numerologies may be provided to a UE.

The numerologies may be defined by a length of cycle prefix (CP) and a subcarrier spacing. One cell may provide a plurality of numerology to a UE. When an index of a numerology is represented by μ, a subcarrier spacing and a corresponding CP length may be expressed as shown in the following table.

TABLE 1

| μ | Δf = 2^{μ} · 5 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

In the case of a normal CP, when an index of a numerology is expressed by μ, the number of OLDM symbols per slot N^{slot}_{symb}, the number of slots per frame Nframe,μslot, and the number of slots per subframe Nsubframe,μslot are expressed as shown in the following table.

TABLE 2

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the case of an extended CP, when an index of a numerology is represented by μ, the number of OLDM symbols per slot N^{slot}_{symb}, the number of slots per frame Nframe,μslot, and the number of slots per subframe Nsubframe,μslot are expressed as shown in the following table.

TABLE 3

| μ | N^{slot}_{symb} | N^{frame, μ}ₛₗₒₜ | N^{subframe, μ}ₛₗₒₜ |
|---|---|---|---|
| 2 | 12 | 40 | 4 |

Meanwhile, in the next-generation mobile communication, each symbol may be used for downlink or uplink, as shown in the following table. In the following table, uplink is indicated by U, and downlink is indicated by D. In the following table, X indicates a symbol that can be flexibly used for uplink or downlink.

TABLE 4

| For- | Symbol Number in Slot | | | | | | | | | | | | | |
|---|---|---|---|---|---|---|---|---|---|---|---|---|---|---|
| mat | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | X | X | X | X | X | X | X | X | X | X | X | X | X | X |
| 3 | D | D | D | D | D | D | D | D | D | D | D | D | D | X |
| 4 | D | D | D | D | D | D | D | D | D | D | D | D | X | X |
| 5 | D | D | D | D | D | D | D | D | D | D | D | X | X | X |
| 6 | D | D | D | D | D | D | D | D | D | D | X | X | X | X |
| 7 | D | D | D | D | D | D | D | D | D | X | X | X | X | X |
| 8 | X | X | X | X | X | X | X | X | X | X | X | X | X | U |
| 9 | X | X | X | X | X | X | X | X | X | X | X | X | U | U |
| 10 | X | U | U | U | U | U | U | U | U | U | U | U | U | U |
| 11 | X | X | U | U | U | U | U | U | U | U | U | U | U | U |
| 12 | X | X | X | U | U | U | U | U | U | U | U | U | U | U |
| 13 | X | X | X | X | U | U | U | U | U | U | U | U | U | U |
| 14 | X | X | X | X | X | U | U | U | U | U | U | U | U | U |
| 15 | X | X | X | X | X | X | U | U | U | U | U | U | U | U |
| 16 | D | X | X | X | X | X | X | X | X | X | X | X | X | X |
| 17 | D | D | X | X | X | X | X | X | X | X | X | X | X | X |
| 18 | D | D | D | X | X | X | X | X | X | X | X | X | X | X |
| 19 | D | X | X | X | X | X | X | X | X | X | X | X | X | U |
| 20 | D | D | X | X | X | X | X | X | X | X | X | X | X | U |
| 21 | D | D | D | X | X | X | X | X | X | X | X | X | X | U |
| 22 | D | X | X | X | X | X | X | X | X | X | X | X | U | U |
| 23 | D | D | X | X | X | X | X | X | X | X | X | X | U | U |
| 24 | D | D | D | X | X | X | X | X | X | X | X | X | U | U |
| 25 | D | X | X | X | X | X | X | X | X | X | X | U | U | U |
| 26 | D | D | X | X | X | X | X | X | X | X | X | U | U | U |
| 27 | D | D | D | X | X | X | X | X | X | X | X | U | U | U |
| 28 | D | D | D | D | D | D | D | D | D | D | D | D | X | U |
| 29 | D | D | D | D | D | D | D | D | D | D | D | X | X | U |
| 30 | D | D | D | D | D | D | D | D | D | D | X | X | X | U |
| 31 | D | D | D | D | D | D | D | D | D | D | D | X | U | U |
| 32 | D | D | D | D | D | D | D | D | D | D | X | X | U | U |
| 33 | D | D | D | D | D | D | D | D | D | X | X | X | U | U |
| 34 | D | X | U | U | U | U | U | U | U | U | U | U | U | U |
| 35 | D | D | X | U | U | U | U | U | U | U | U | U | U | U |
| 36 | D | D | D | X | U | U | U | U | U | U | U | U | U | U |
| 37 | D | X | X | U | U | U | U | U | U | U | U | U | U | U |
| 38 | D | D | X | X | U | U | U | U | U | U | U | U | U | U |
| 39 | D | D | D | X | X | U | U | U | U | U | U | U | U | U |
| 40 | D | X | X | X | U | U | U | U | U | U | U | U | U | U |
| 41 | D | D | X | X | X | U | U | U | U | U | U | U | U | U |
| 42 | D | D | D | X | X | X | U | U | U | U | U | U | U | U |
| 43 | D | D | D | D | D | D | D | D | D | X | X | X | X | U |
| 44 | D | D | D | D | D | D | X | X | X | X | X | X | U | U |
| 45 | D | D | D | D | D | D | X | X | U | U | U | U | U | U |
| 46 | D | D | D | D | D | D | X | D | D | D | D | D | D | X |
| 47 | D | D | D | D | D | X | X | D | D | D | D | D | X | X |
| 48 | D | D | X | X | X | X | X | D | D | X | X | X | X | X |
| 49 | D | X | X | X | X | X | X | D | X | X | X | X | X | X |
| 50 | X | U | U | U | U | U | U | X | U | U | U | U | U | U |
| 51 | X | X | U | U | U | U | U | X | X | U | U | U | U | U |
| 52 | X | X | X | U | U | U | U | X | X | X | U | U | U | U |
| 53 | X | X | X | X | U | U | U | X | X | X | X | U | U | U |
| 54 | D | D | D | D | D | X | U | D | D | D | D | D | X | U |
| 55 | D | D | X | U | U | U | U | D | D | X | U | U | U | U |
| 56 | D | X | U | U | U | U | U | D | X | U | U | U | U | U |
| 57 | D | D | D | D | X | X | U | D | D | D | D | X | X | U |
| 58 | D | D | X | X | U | U | U | D | D | X | X | U | U | U |
| 59 | D | X | X | U | U | U | U | D | X | X | U | U | U | U |
| 60 | D | X | X | X | X | X | U | D | X | X | X | X | X | U |
| 61 | D | D | X | X | X | X | U | D | D | X | X | X | X | U |

### Operating Band in NR

An operating band in NR is as follows.

An operating band shown in Table 9 is a reframing operating band that is transitioned from an operating band of LTE/LTE-A. This operating band is referred to as FR1 band.

TABLE 5

| NR | Uplink Operating | Downlink Operating | |
|---|---|---|---|
| operating | Band | Band | Duplex |
| band | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n50 | 1432 MHz-1517 MHz | 1432 MHz-1517 MHz | TDD1 |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

The following table shows an NR operating band defined at high frequencies. This operating band is referred to as FR2 band.

TABLE 6

| NR | Uplink Operating | Downlink Operating | |
|---|---|---|---|
| Operating | Band | Band | Duplex |
| Band | F_{UL}_{_{—}}_{low}-F_{UL}_{_{—}}_{high} | F_{DL}_{_{—}}_{low}-F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 39500 MHz-43500 MHz | 39500 MHz-43500 MHz | TDD |
| n260 | 37000 MHz-40000 MHz | 37000 MHz-40000 MHz | TDD |
| n261 | 27500 MHz-28350 MHz | 27500 MHz-28350 MHz | TDD |

Meanwhile, when the operating band shown in the above table is used, a channel bandwidth is used as shown in the following table.

TABLE 7

| SCS | 5 MHz | 10 MHz | 15 MHz | 20 MHz | 25 MHz | 30 MHz | 40 MHz | 50 MHz | 60 MHz | 80 MHz | 100 MHz |
|---|---|---|---|---|---|---|---|---|---|---|---|
| (kHz) | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N/A | N/A | N/A |
| 30 | 11 | 24 | 38 | 51 | 65 | [78] | 106 | 133 | 162 | 217 | 273 |
| 60 | N/A | 11 | 18 | 24 | 31 | [38] | 51 | 65 | 79 | 107 | 135 |

In the above table, SCS indicates a subcarrier spacing. In the above table, NRB indicates the number of RBs.

Meanwhile, when the operating band shown in the above table is used, a channel bandwidth is used as shown in the following table.

TABLE 8

| SCS | 50 MHz | 100 MHz | 200 MHz | 400 MHz |
|---|---|---|---|---|
| (kHz) | N_{RB} | N_{RB} | N_{RB} | N_{RB} |
| 60 | 66 | 132 | 264 | N.A |
| 120 | 32 | 66 | 132 | 264 |

### SS Block in NR

In the 5G NR, information required for a UE to perform an initial access, that is, a Physical Broadcast Channel (PBCH) including a Master Information Block (MIB) and a synchronization signal (SS) (including PSS and SSS) are defined as an SS block. In addition, a plurality of SS blocks may be grouped and defined as an SS burst, and a plurality of SS bursts may be grouped and defined as an SS burst set. It is assumed that each SS block is beamformed in a particular direction, and various SS blocks existing in an SS burst set are designed to support UEs existing in different directions.

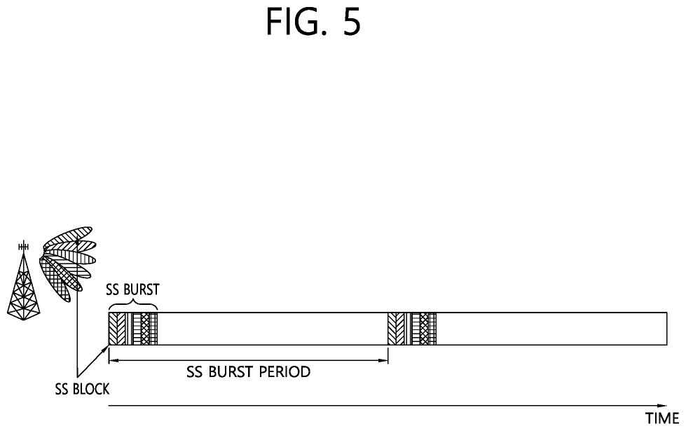

FIG. 5 is a diagram illustrating an example of an SS block in NR.

Referring to FIG. 5, an SS burst is transmitted in every predetermined periodicity.

Accordingly, a UE receives SS blocks, and performs cell detection and measurement.

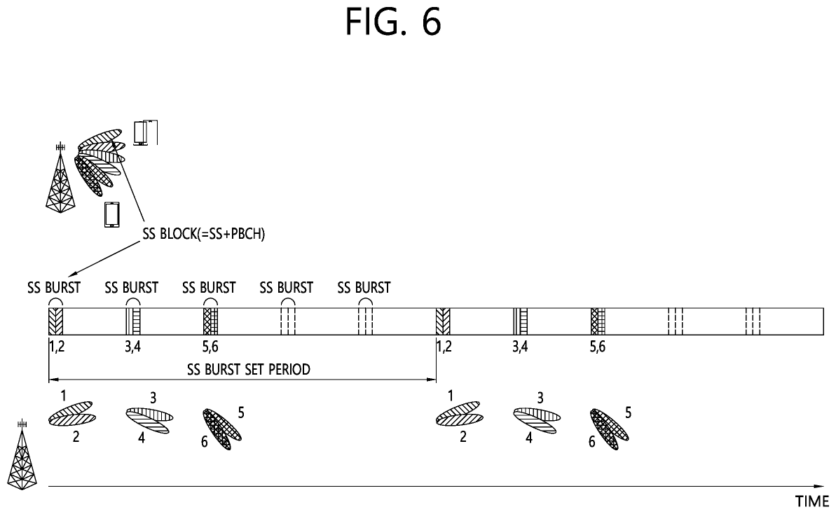

Meanwhile, in the 5G NR, beam sweeping is performed on an SS. A detailed description thereof will be provided with reference to FIG. 6.

FIG. 6 is a diagram illustrating an example of beam sweeping in the NR.

A base station transmits each SS block in an SS burst over time while performing beam sweeping. In this case, multiple SS blocks in an SS burst set are transmitted to support UEs existing in different directions. In FIG. 6, the SS burst set includes one to six SS blocks, and each SS burst includes two SS blocks.

### Maximum Output Power

Power class 1, 2, 3, and 4 are specified based on UE types as follows:

TABLE 9

| UE Power class | UE type |
|---|---|
| 1 | Fixed wireless access (FWA) UE |
| 2 | Vehicular UE |
| 3 | Handheld UE |
| 4 | High power non-handheld UE |

### 1. UE Maximum Output Power For Power Class 1

The following requirements define the maximum output power radiated by the UE for any transmission bandwidth within the channel bandwidth for non-CA configuration, unless otherwise stated. The period of measurement shall be at least one sub frame (1 ms). The requirement is verified with the test metric of effective isotropic radiated power (EIRP) (Link=Beam peak search grids, Meas=Link angle).

Below table shows UE minimum peak EIRP for power class 1.

TABLE 10

| Operating band | Min peak EIRP (dBm) |
|---|---|
| n257 | 40.0 |
| n258 | 40.0 |
| n260 | 38.0 |
| n261 | 40.0 |

The maximum output power values for total radiated power (TRP) and EIRP are found in below table. The maximum allowed EIRP is derived from regulatory requirements [8]. The requirements are verified with the test metrics of TRP (Link=TX beam peak direction) in beam locked mode and EIRP (Link=TX beam peak direction, Meas=Link angle).

Below table shows UE maximum output power limits for power class 1.

TABLE 11

| Operating band | Max TRP (dBm) | Max EIRP (dBm) |
|---|---|---|
| n257 | 35 | 55 |
| n258 | 35 | 55 |
| n260 | 35 | 55 |
| n261 | 35 | 55 |

The minimum EIRP at the 85^{th} percentile of the distribution of radiated power measured over the full sphere around the UE is defined as the spherical coverage requirement and is found in below table. The requirement is verified with the test metric of EIRP (Link=Beam peak search grids, Meas=Link angle).

Below table shows UE spherical coverage for power class 1.

TABLE 12

| Operating band | Min EIRP at 85%-tile CDF (dBm) |
|---|---|
| n257 | 32.0 |
| n258 | 32.0 |
| n260 | 30.0 |
| n261 | 32.0 |

### 2. UE Maximum Output Power for Power Class 2

The following requirements define the maximum output power radiated by the UE for any transmission bandwidth within the channel bandwidth for non-CA configuration, unless otherwise stated. The period of measurement shall be at least one sub frame (1 ms). The requirement is verified with the test metric of EIRP (Link=Beam peak search grids, Meas=Link angle).

Below table shows UE minimum peak EIRP for power class 2.

TABLE 13

| Operating band | Min peak EIRP (dBm) |
|---|---|
| n257 | 29 |
| n258 | 29 |
| n261 | 29 |

The maximum output power values for TRP and EIRP are found in below table. The maximum allowed EIRP is derived from regulatory requirements [8]. The requirements are verified with the test metrics of TRP (Link=TX beam peak direction) in beam locked mode and EIRP (Link=TX beam peak direction, Meas=Link angle).

Below table shows UE maximum output power limits for power class 2.

TABLE 14

| Operating band | Max TRP (dBm) | Max EIRP (dBm) |
|---|---|---|
| n257 | 23 | 43 |
| n258 | 23 | 43 |
| n261 | 23 | 43 |

The minimum EIRP at the 60^{th} percentile of the distribution of radiated power measured over the full sphere around the UE is defined as the spherical coverage requirement and is found in below table. The requirement is verified with the test metric of EIRP (Link=Beam peak search grids, Meas=Link angle).

Below table shows UE spherical coverage for power class 2.

TABLE 15

| Operating band | Min EIRP at 60%-tile CDF (dBm) |
|---|---|
| n257 | 18.0 |
| n258 | 18.0 |
| n261 | 18.0 |

### 3. UE Maximum Output Power for Power Class 3

The following requirements define the maximum output power radiated by the UE for any transmission bandwidth within the channel bandwidth for non-CA configuration, unless otherwise stated. The period of measurement shall be at least one sub frame (1 ms). The requirement is verified with the test metric of total component of EIRP (Link=Beam peak search grids, Meas=Link angle). The requirement for the UE which supports a single FR2 band is specified in below table. The requirement for the UE which supports multiple FR2 bands is specified in both below tables.

Below table shows UE minimum peak EIRP for power class 3

TABLE 16

| Operating band | Min peak EIRP (dBm) |
|---|---|
| n257 | 22.4 |
| n258 | 22.4 |
| n259 | 18.7 |
| n260 | 20.6 |
| n261 | 22.4 |

The maximum output power values for TRP and EIRP are found on the below table. The max allowed EIRP is derived from regulatory requirements [8]. The requirements are verified with the test metrics of TRP (Link=TX beam peak direction) in beam locked mode and the total component of EIRP (Link=TX beam peak direction, Meas=Link angle).

Below table shows UE maximum output power limits for power class 3

TABLE 17

| Operating band | Max TRP (dBm) | Max EIRP (dBm) |
|---|---|---|
| n257 | 23 | 43 |
| n258 | 23 | 43 |
| n259 | 23 | 43 |
| n260 | 23 | 43 |
| n261 | 23 | 43 |

The minimum EIRP at the 50^{th} percentile of the distribution of radiated power measured over the full sphere around the UE is defined as the spherical coverage requirement and is found in below table. The requirement is verified with the test metric of the total component of EIRP (Link=Beam peak search grids, Meas=Link angle). The requirement for the UE which supports a single FR2 band is specified in the below table. The requirement for the UE which supports multiple FR2 bands is specified in both below tables.

Below table shows UE spherical coverage for power class 3.

TABLE 18

| Operating band | Min EIRP at 50%-tile CDF (dBm) |
|---|---|
| n257 | 11.5 |
| n258 | 11.5 |
| n259 | 5.8 |
| n260 | 8 |
| n261 | 11.5 |

For the UEs that support multiple FR2 bands, minimum requirement for peak EIRP and EIRP spherical coverage in above tables shall be decreased per band, respectively, by the peak EIRP relaxation parameter ΔMB_{P,n} and EIRP spherical coverage relaxation parameter ΔMB_{S,n}. For each combination of supported bands ΔMB_{P,n} and ΔMB_{S,n} apply to each supported band n, such that the total relaxations, ΣMB_{P} and ΣMB_{S}, across all supported bands shall not exceed the total value indicated in the below table.

Below table shows UE multi-band relaxation factors for power class 3.

TABLE 19

| Supported bands | ΣMBP (dB) | ΣMBS (dB) |
|---|---|---|
| n257, n258 | ≤1.3 | ≤1.25 |
| n257, n260 | ≤1.0 | ≤0.753 |
| n258, n260 | | |
| n257, n261 | 0.0 | 0.0 |
| n258, n261 | ≤1.0 | ≤1.25 |
| n260, n261 | 0.0 | ≤0.752 |
| n257, n258, n260 | ≤1.7 | ≤1.753 |
| n257, n258, n261 | | |
| n257, n258, n260, n261 | | |
| n257, n260, n261 | ≤0.5 | ≤1.253 |
| n258, n260, n261 | ≤1.5 | ≤1.253 |

### 4. UE Maximum Output Power for Power Class 4

The following requirements define the maximum output power radiated by the UE for any transmission bandwidth within the channel bandwidth for non-CA configuration, unless otherwise stated. The period of measurement shall be at least one sub frame (1 ms). The requirement is verified with the test metric of EIRP (Link=Beam peak search grids, Meas=Link angle).

Below table shows UE minimum peak EIRP for power class 4.

TABLE 20

| Operating band | Min peak EIRP (dBm) |
|---|---|
| n257 | 34 |
| n258 | 34 |
| n260 | 31 |
| n261 | 34 |

The maximum output power values for TRP and EIRP are found in the below table. The maximum allowed EIRP is derived from regulatory requirements [8]. The requirements are verified with the test metrics of TRP (Link=TX beam peak direction) in beam locked mode and EIRP (Link=TX beam peak direction, Meas=Link angle).

Below table shows UE maximum output power limits for power class 4.

TABLE 21

| Operating band | Max TRP (dBm) | Max EIRP (dBm) |
|---|---|---|
| n257 | 23 | 43 |
| n258 | 23 | 43 |
| n260 | 23 | 43 |
| n261 | 23 | 43 |

The minimum EIRP at the 20^{th} percentile of the distribution of radiated power measured over the full sphere around the UE is defined as the spherical coverage requirement and is found in the below table. The requirement is verified with the test metric of EIRP (Link=Beam peak search grids, Meas=Link angle).

Below table shows UE spherical coverage for power class 4.

TABLE 22

| Operating band | Min EIRP at 20%-tile CDF (dBm) |
|---|---|
| n257 | 25 |
| n258 | 25 |
| n260 | 19 |
| n261 | 25 |

### Disclosure of the Present Disclosure

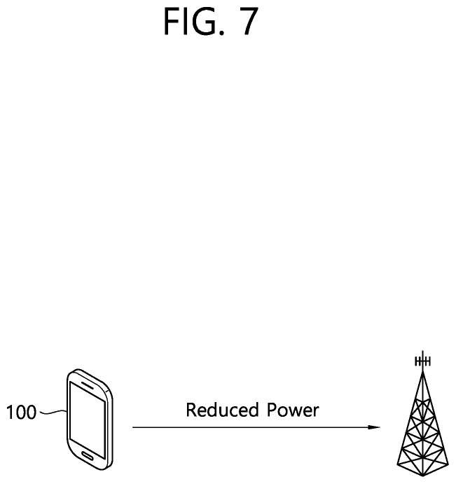

FIG. 7 illustrates an example of a method of limiting transmission power of a wireless device.

As can be seen from FIG. 7, the wireless device (or UE) 100 transmits a signal at a power reduced by a value of a maximum power reduction (MPR).

Meanwhile, high frequencies such as mmWave in FR2 band of Table 6 may conduct a human body.

In order to prevent the high frequencies such as mmWave from conducting the human body, a maximum permissible exposure (MPE) limitation is needed.

The MPE limitation may be satisfied by either a power management UE maximum power reduction (P-MPR) or a maximum uplink duty cycle or by both of them.

The maximum uplink duty cycle means a percentage of uplink symbols transmitted within any is evaluation period. That is, the maximum uplink duty cycle means a radio of uplink symbols within time division duplex (TDD) uplink symbols and downlink symbols.

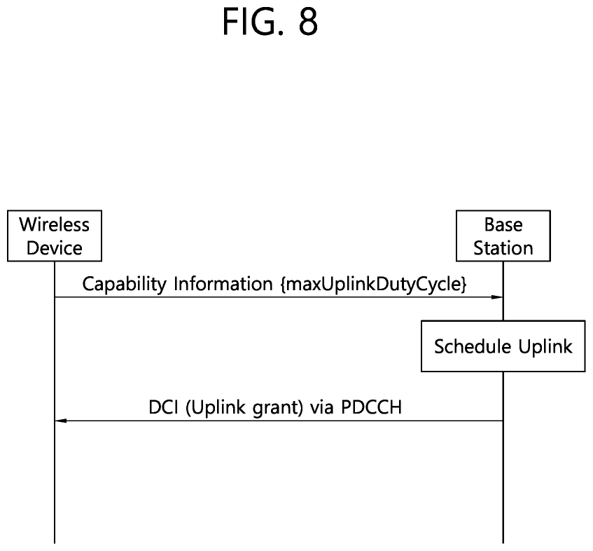

FIG. 8 shows an exemplary flow for transmitting capability information.

Referring to FIG. 8, the wireless device transmits capability information including the maximum uplink duty cycle to a base station (e.g., gNB).

The base station (e.g., gNB) performs an uplink scheduling based on the capability information of the wireless device.

And then, the base station (e.g., gNB) transmits downlink control information (DCI) including an uplink grant via a PDCCH.

However, if the wireless device may not transmit the capability information including the maximum uplink duty cycle, a problem occurs that the base station could not limit the percentage of uplink symbols transmitted within the given period.

Also, it is not apparent how the maximum uplink duty cycle limits. That is, there is no candidate percentile of maxUplinkDutyCycle to satisfy the MPE regulatory requirements and Specific Absorption Rate (SAR) limitation at both FR1 and FR2.

Furthermore, a required level of P-MPR has not been studded.

Accordingly, the present disclosure provides test results for SAR and MPE for both NSA and SA NR UE. Also the present disclosure proposes candidate solution to satisfy the basic restriction of human exposure at both FR1 and FR2.

It may be considered to remove the P-MPR upper limitation to compliance the Maximum permissible Exposure limitation at mmWave using P-MPR or the restricted maxUplinkDutyCycle or both P-MPR and maxUplinkDutyCycle restriction.

However, the default value of maxUplinkDutyCycle is being still researched when the wireless device did not report maxUplinkDutyCycle level to satisfy the MPE regulatory requirements at FR2.

The present disclosure provides measured results for MPE for both NSA and SA NR UE. Also the present disclosure proposes the default value of maxUplinkDutyCycle to guarantee the network coverage without P-MPR which was same principle to decide maxUplinkDutyCycle at FR1. Also this proposal can be minimize the human exposure impact when early released UE did not report the maxUplinkDutyCycle to network at FR2 in real market.

### I. First Disclosure: MPE Measurements for SA UE at mmWave

The updated U.S. Federal Communications Commission (FCC) and International Commission on Non-Ionizing Radiation Protection (ICNIRP) limitations are introduced in the below table.

Below table shows general public RF Maximum Permissible Exposure limits above the frequency fₜᵣ (f=frequency in GHz)

TABLE 23

| | | | ICNIRP | |
|---|---|---|---|---|
| | FCC | | | New |
| | Old | New | Old | (Reference levels) |
| fₜᵣ (GHz) | 6 | 6 | 10 | 6 |
| Incident power | 10 | 10 | 10 | 55*f--0.177 |
| density | | | | 30 (at 28 GHz) |
| (W/m2) | | | | 28 (at 39 GHz) |
| f >= fₜᵣ | | | | |
| Averaging area | 1 cm2 | 4 cm2 | 20 cm2 | 4 cm2 up to 30 |
| | | | | GHz and 1 cm2 |
| | | | | above |

From the above table, it seems that the FCC regulation is tighter than ICNIRP limitation at 28 GHz.

To measure the RF exposure levels in human body, it may consider two antenna panels and 4Tx antenna elements per panel as shown in below table.

Below table shows NR UE parameters for measurements

TABLE 24

| UE parameters | Unit | |
|---|---|---|
| Operating band | | n260/n261 |
| # of antenna in an array (# of patches, # of | | One 2 × 2 patch |
| dipoles, etc.) | | |
| # of arrays in total | | 2 |
| Antenna type (patch, dipole, or both) | | patch |
| Antenna location (front, back, top-side, | | Left & Right |
| left-side, right-side, bottom-side) | | |
| Device case material (Plastic, Glass, | dB | Metal |
| Ceramic, Metal) | | |
| Device size (3D) | cm3 | Over 150 mm |
| | | of length |
| Legacy Antenna (w/Metal, Plastic Frame) | | Plastic |
| Display panel | Y/N | Y |
| Bezel Margin | Y/N | N/A |
| Gap between antenna & housing | mm | N/A |

Based on these regulatory limitation, the RF exposure level of NR UE are measured at n261/n260 operating bands.

Below table shows measured RF Exposure levels at 28 GHz/39 GHz.

TABLE 25

| | | | | | | | | | Avg. Area |
|---|---|---|---|---|---|---|---|---|---|
| | | | | Uplink | | | | AG0 + | [4 cm\hat{ }2] |
| Operating | Measured | Test | TestGrid | Duty | | | | AG1 | PD |
| Band | Condition | Distance | Size | Cycle | CH | | | EIRP | (W/m\hat{ }2) |
| n261 | Left side | 0 mm | 20 × 20 mm | 50.0% | Low | AG0 | AG1 | 20.4 | 21.6 |
| n261 | Front | 0 mm | 20 × 20 mm | 50.0% | Low | (H) | (V) | 20.4 | 10.2 |
| n261 | Rear | 0 mm | 20 × 20 mm | 50.0% | Low | | | 20.4 | 8.7 |
| n261 | Left side | 0 mm | 20 × 20 mm | 25% | Low | | | 17.4 | 10.8 |
| n261 | Front | 0 mm | 20 × 20 mm | 25% | Low | | | 17.4 | 5.03 |
| n261 | Rear | 0 mm | 20 × 20 mm | 25% | Low | | | 17.4 | 4.45 |
| n261 | Left side | 0 mm | 20 × 20 mm | 12.5% | Low | | | 14.4 | 5.4 |
| n261 | Front | 0 mm | 20 × 20 mm | 12.5% | Low | | | 14.4 | 2.54 |
| n261 | Rear | 0 mm | 20 × 20 mm | 12.5% | Low | | | 14.4 | 2.2 |
| n261 | Left side | 0 mm | 20 × 20 mm | 6.25% | Low | | | 11.4 | 2.8 |
| n260 | Left side | 0 mm | 20 × 20 mm | 50% | Low | | | 19.6 | 14.8 |
| n260 | Front | 0 mm | 20 × 20 mm | 50% | Low | | | 19.6 | 4.9 |
| n260 | Rear | 0 mm | 20 × 20 mm | 50% | Low | | | 19.6 | 4.2 |
| n260 | Left side | 0 mm | 20 × 20 mm | 25% | Low | | | 16.6 | 7.3 |
| n260 | Front | 0 mm | 20 × 20 mm | 25% | Low | | | 16.6 | 2.4 |
| n260 | Rear | 0 mm | 20 × 20 mm | 25% | Low | | | 16.6 | 2.0 |

Note:
H means polarization of Horizontal domain. V means polarization of Vertical domain.

First of all, the present disclosure considers the 0 dB P-MPR to maintain the cell coverage, so that the restricted maxUplinkDutyCycle may be used to meet the RF exposure limitation. From the above table, the measured average power density level of UE's left side is exceeded the FCC regulation as 10 W/m2 using the restricted maxUplinkDutyCycle with 25%.

So the NR UE do not launch at real market due to violate the FCC limitation when the maxUplinkDutyCycle is larger than 12.5% with 0 dB P-MPR.

Especially, the patch antenna located position will be critical impact to meet the RF exposure limitation since RF exposure test shall meet the all direction of UE such as Left/Right side, top, front and rear side for compliance of FCC regulation test.

Based on these analysis, the required total power reduction level is about 9 dB. Therefore, the required P-MPR and maxUplinkDutyCycle could be derived to meet the RF exposure requirements as shown in below table.

Below table shows combination of P-MPR and maxUplinkDutyCycle.

TABLE 26

| | Total required | | |
|---|---|---|---|
| | Power reduction | P-MPR_{f, c} | maxUplinkDutyCycle |
| Operating Band | [dB] | [dB] | [%] |
| n257, n258, | 9 dB | 0 | maxUplinkDutyCycle <= 12.5 |
| n260, n261 | | 3 | 12.5 < maxUplinkDutyCycle <= 25 |
| | | 6 | 25 < maxUplinkDutyCycle <= 50 |
| | | 9 | 50 < maxUplinkDutyCycle <= 100 |

Meanwhile, there may be a concern to apply large P-MPR values for RF exposure limitation since the cell coverage critically shrank by large P-MPR level.

So, it is recommended to use only the restricted maxUplinkDutyCycle for RF exposure limitation when the required total power reduction level is less than 9 dB from peak EIRP level of UE. If the required power reduction level is larger than 9 dB, then, both P-MPR and the restricted maxUplinkDutyCycle may be used for RF exposure limitation.

Proposal 1: To meet the RF exposure limitation at mmWave, it is proposed to use only the restricted maxUplinkDutyCycle when the required total power reduction level is equal or less than 9 dB.

Proposal 2: Both P-MPR and the restricted maxUplinkDutyCycle can be used for RF exposure limitation when the required total power reduction level is larger than 9 dB.

Based on these measurement, the total required power reduction level is about 6 dB.

The NR UE at FR2 can satisfy the MPE regulatory requirements as follow three options.

Option1) Apply P-MPR with 6 dB and 100% maxUplinkDutyCycle

Option2) Apply P-MPR with 0 dB and 20% maxUplinkDutyCycle

Option3) Apply both P-MPR and maxUplinkDutyCycle depend on UE implementation

The below table shows summary the pros & cons for each options

TABLE 27

| Solution | Pros | Cons |
|---|---|---|
| Option1 | TDD UL/DL configuration is | Shrink the cell coverage |
| | not restricted | Initial access is restricted area |
| | Early released 5G UE easily | RAN2 signalling is not |
| | satisfied the MPE | support P-MPR reporting |
| | | from UE |
| Option2 | Maintain the cell coverage | TDD UL/DL configuration is |
| | Initial access is not | restricted. |
| | restricted area | |
| | RAN2 signalling is support | |
| | maxUplinkDutyCycle | |
| | reporting from UE | |
| | Early released 5G UE easily | |
| | satisfied the MPE | |
| Option3 | Simple to satisfy MPE | RAN2 signaling is not support |
| | | P-MPR reporting from UE |
| | | Early released UE do not |
| | | provide any information to |
| | | NW for both P-MPR & |
| | | maxUplinkDutyCycle |

The problem of the 100% maxUplinkDutyCycle as default value is that P-PMR always applied to satisfy the MPE regulatory requirements. It will be raised the cell coverage decreased problem. Then 5G UE initial access is quite difficult compare to NR FR1.

Also the early released NR UE without maxUplinkDutyCycle capability signaling in early market did not satisfy the MPE with 100% default value of maxUplinkDutyCycle. Then the early released 5G UE always applied P-MPR with certain dB, it quite impact to shrink the cell coverage.

However, if the 20% maxUplinkDutyCycle as default value is not necessary P-PMR level for compliance the MPE regulatory requirements. Also the early released 5G UE always satisfy MPE requirements for 20% default value of maxUplinkDutyCycle without P-MPR. Finally do not impact to the cell coverage.

This 20% default value of maxUplinkDutyCycle is derived as same approach when RAN4 decide the default value of maxUplinkDutyCycle at FR1.

In other words, 50% default value was decided with P-MPR 0 dB for power class 2 UE at FR1 since network consider the default values without any P-MPR report from UE side.

Therefore, the present disclosure proposes the default value of maxUplinkDutyCycle at FR2 as following

Proposal 3: The default value of maxUplinkDutyCycle should be decided with 20% duty cycle ratio. The minimum percentile of reporting range is 20%.

Based on the measurement results and the analysis, the required P-MPR and maxUplinkDutyCycle to meet the RF exposure requirements are summarized as shown in the below table.

The below table shows combination of P-MPR and maxUplinkDutyCycle.

TABLE 28

| | Total required | | | |
|---|---|---|---|---|
| | Power reduction | P-MPRf, c | maxUplinkDutyCycle | |
| Operating Band | [dB] | [dB] | [%] | Note |
| n257, n258, | <6 dB | 0 | 20 <= | Default value of |
| n260, n261 | | | maxUplinkDutyCycle <= | maxUplinkDutyCycle |
| | | | 25 | is 20% with 0 dB P- |
| | | | | MPR |
| | | 3 | 25 < | only |
| | | | maxUplinkDutyCycle <= | maxUplinkDutyCycle |
| | | | 50 | |
| | | 6 | 50 < | can be used to maintain |
| | | | maxUplinkDutyCycle <= | cell coverage |
| | | | 100 | |
| | >6 dB | X | 20 <= | Both P-MPR & |
| | | | maxUplinkDutyCycle <= | maxUplinkDutyCycle |
| | | | 100 | used to satisfy MPE |
| | | | | regulatory |
| | | | | requirements |

If the total required MPR level is larger than 6 dB, it is considered to use both P-MPR and the restricted maxUplinkDutyCycle for RF exposure limitation as shown in the above table. Then, P-MPR also need to specify the UE capability signalling.

It means that the applied P-MPR with certain dB in UE side is not reported network, then network can scheduled the higher maximum power regardless of P-MPR level in cell edge region, then UE autonomously apply P-MPR, hence the UE can be released from network connection by network failure.

Based on these analyses, it is proposed as follow:

Proposal 4: it is proposed to use the restricted maxUplinkDutyCycle when the required total power reduction level is equal or less than about 6 dB (i.e., ±6 dB such as 5 dB or 7 dB). Both P-MPR and the restricted maxUplinkDutyCycle can be used for RF exposure limitation when the required total power reduction level is larger than about 6 dB (i.e., ±6 dB such as 5 dB or 7 dB).

Proposal 5: it is needed to specify the UE capability signalling for P-MPR reporting.

### II. Second Disclosure: Modification to the 3GPP Standard

The UE can configure its maximum output power. The configured UE maximum output power P_{CMAX,fc} for carrier f of a serving cell c is defined as that available to the reference point of a given transmitter branch that corresponds to the reference point of the higher-layer filtered RSRP measurement.

The configured UE maximum output power P_{CMAX,f,c} for carrier f of a serving cell c shall be set such that the corresponding measured peak EIRP P_{UMAX,f,c} is within the following bounds

P_{Powerclass}−MAX(MPR_{f,c}+ΔMB_{P,n}, P-MPR_{f,c})−MAX{T(MPR_{f,c}), T(P-MPR_{f,c})}≤P_{UMAX,f,c}≤EIRPₘₐₓ [Equation 1]

while the corresponding measured total radiated power P_{TMAX,f,c} is bounded by

P_{TMAX,f,c}≤TRPₘₐₓ [Equation 2]

P_{Powerclass} is the UE power class, EIRPₘₐₓ is the applicable maximum EIRP, ΔMB_{P,n} is the peak EIRP relaxation and TRPₘₐₓ is the maximum TRP for the UE power class.

P-MPR_{f,c} is the allowed maximum output power reduction and maxUplinkDutyCycle is the UE's reported maximum duty cyle to facilitate the compliance described below with P-MPR_{f,c}. The evaluation period for maxUplinkDutyCycle is 1s.

The Below table shows combination of P-MPRf,c and maxUplinkDutyCycle

TABLE 29

| Operating Band | P-MPRf, c | maxUplinkDutyCycle [%] |
|---|---|---|
| n257, n258, | 0 | 20 ≤ maxUplinkDutyCycle ≤ 25 |
| n260, n261 | | |

a) ensuring compliance with applicable electromagnetic energy absorption requirements and addressing unwanted emissions/self defense requirements in case of simultaneous transmissions on multiple RAT(s) for scenarios not in scope of 3GPP RAN specifications;

b) ensuring compliance with applicable electromagnetic energy absorption requirements in case of proximity detection is used to address such requirements that require a lower maximum output power.

The UE shall apply P-MPR_{f,c} for carrier f of serving cell c and the maxUplinkDutyCycle only for the above cases. For UE conformance testing P-MPR_{f,c} shall be 0 dB.

P-MPR_{f,c} was introduced in the P_{CMAX,f,c} equation such that the UE can report to the gNB the available maximum output transmit power. This information can be used by the gNB for scheduling decisions.

P-MPR_{f,c} and maxUplinkDutyCycle may impact the maximum uplink performance for the selected UL transmission path.

The tolerance T(ΔP) for applicable values of ΔP (values in dB) is specified in the below table.

The below table shows P_{UMAX,f,c} tolerance of Power class 3 UE.

TABLE 30

| Operating Band | ΔP (dB) | Tolerance T(ΔP) (dB) |
|---|---|---|
| n257, n258, | ΔP = 0 | 0 |
| n259, n260, | 0 < ΔP ≤ 2 | 1.5 |
| n261 | 2 < ΔP ≤ 3 | 2.0 |
| | 3 < ΔP ≤ 4 | 3.0 |
| | 4 < ΔP ≤ 5 | 4.0 |
| | 5 < ΔP ≤ 10 | 5.0 |
| | 10 < ΔP ≤ 15 | 7.0 |
| | 15 < ΔP ≤ X | 8.0 |

X is the value such that Pumax,f,c lower bound, PPowerclass−ΔP−T(ΔP)=minimum output power.

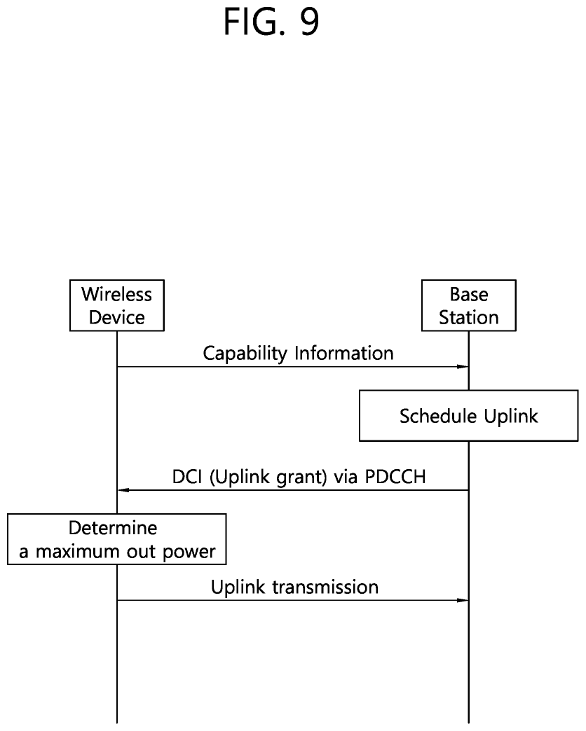

FIG. 9 shows an exemplary signal flows of the present disclosure.

Referring to FIG. 9, a user equipment (UE) transmits capability information to a base station (e.g., gNB).

The base station (e.g., gNB) performs an uplink scheduling based on the capability information of the UE.

And then, the base station (e.g., gNB) transmits downlink control information (DCI) including an uplink grant via a PDCCH.

The UE may determine a maximum output power.

Based on that the capability information does not includes a maximum uplink duty cycle, the maximum output power is determined by using a P-MPR.

The maximum uplink duty cycle may represent a maximum percentage of symbols used for uplink transmission during a given time period.

The P-MPR may be applied to satisfy a power exposure requirement.

The method may further comprise: transmitting information on the determined maximum output power.

The maximum uplink duty cycle may be defined for a frequency range (FR) 2.

The FR2 may include a n257 band, a n258 band, a n260 band and a n261 band.

The above-described embodiments of the present disclosure may be implemented by use of various means. For example, the embodiments of the present disclosure may be implemented by hardware, firmware, and software or a combination thereof. A detailed description thereof will be provided with reference to drawings.

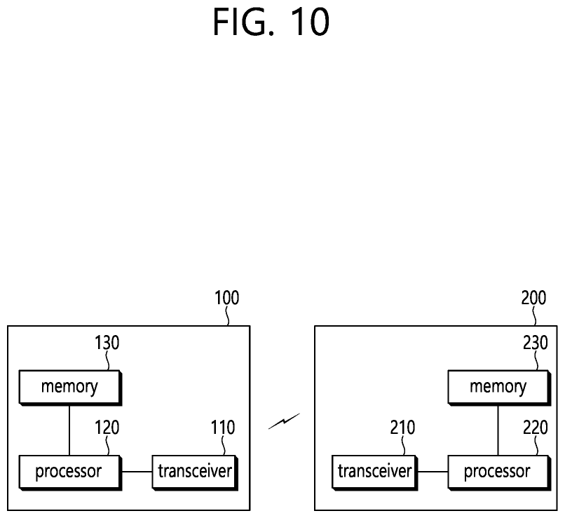

FIG. 10 is a block diagram illustrating a wireless device and a base station, by which the disclosure of this specification can be implemented.

Referring to FIG. 10, a wireless device 100 and a base station 200 may implement the disclosure of this specification.

The wireless device 100 includes a processor 101, a memory 102, and a transceiver 103. Likewise, the base station 200 includes a processor 201, a memory 202, and a transceiver 203. The processors 101 and 201, the memories 102 and 202, and the transceivers 103 and 203 may be implemented as separate chips, or at least two or more blocks/functions may be implemented through one chip.

Each of the transceivers 103 and 203 includes a transmitter and a receiver. When a particular operation is performed, either or both of the transmitter and the receiver may operate. Each of the transceivers 103 and 203 may include one or more antennas for transmitting and/or receiving a radio signal. In addition, each of the transceivers 103 and 203 may include an amplifier configured for amplifying a Rx signal and/or a Tx signal, and a band pass filter for transmitting a signal to a particular frequency band.

Each of the processors 101 and 201 may implement functions, procedures, and/or methods proposed in this specification. Each of the processors 101 and 201 may include an encoder and a decoder. For example, each of the processors 101 and 202 may perform operations described above. Each of the processors 101 and 201 may include an application-specific integrated circuit (ASIC), a different chipset, a logic circuit, a data processing device, and/or a converter which converts a base band signal and a radio signal into each other.

Each of the memories 102 and 202 may include a Read-Only Memory (ROM), a Random Access Memory (RAM), a flash memory, a memory card, a storage medium, and/or any other storage device.

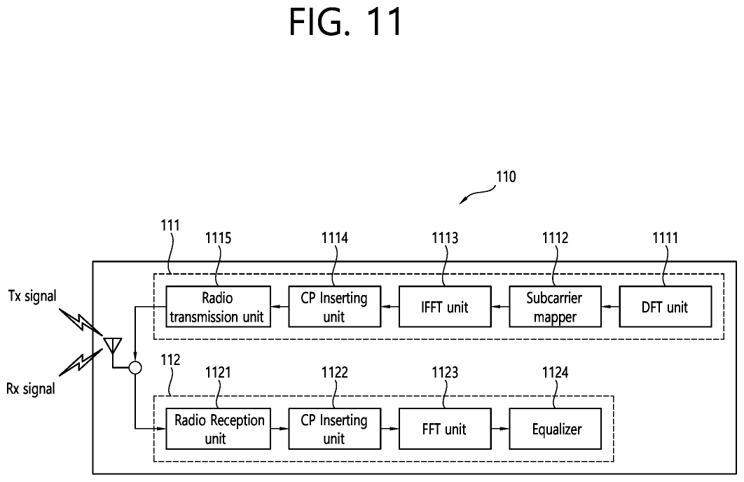

FIG. 11 is a detailed block diagram illustrating a transceiver of the wireless device shown in FIG. 10.

Referring to FIG. 11, a transceiver 110 includes a transmitter 111 and a receiver 112. The transmitter 111 includes a Discrete Fourier Transform (DFT) unit 1111, a subcarrier mapper 1112, an IFFT unit 1113, a CP insertion unit 1114, a wireless transmitter 1115. In addition, the transceiver 1110 may further include a scramble unit (not shown), a modulation mapper (not shown), a layer mapper (not shown), and a layer permutator, and the transceiver 110 may be disposed in front of the DFT unit 1111. That is, in order to prevent a peak-to-average power ratio (PAPR) from increasing, the transmitter 111 may transmit information to pass through the DFT unit 1111 before mapping a signal to a subcarrier. A signal spread (or pre-coded for the same meaning) by the DFT unit 111 is subcarrier-mapped by the subcarrier mapper 1112, and then generated as a time domain signal by passing through the IFFT unit 1113.

The DFT unit 111 performs DFT on input symbols to output complex-valued symbols. For example, if Ntx symbols are input (here, Ntx is a natural number), a DFT size may be Ntx. The DFT unit 1111 may be called a transform precoder. The subcarrier mapper 1112 maps the complex-valued symbols to subcarriers of a frequency domain. The complex-valued symbols may be mapped to resource elements corresponding to a resource block allocated for data transmission. The subcarrier mapper 1112 may be called a resource element mapper. The IFFT unit 113 may perform IFFT on input symbols to output a baseband signal for data, which is a time-domain signal. The CP inserter 1114 copies a rear portion of the baseband signal for data and inserts the copied portion into a front part of the baseband signal. The CP insertion prevents Inter-Symbol Interference (ISI) and Inter-Carrier Interference (ICI), and therefore, orthogonality may be maintained even in multi-path channels.

Meanwhile, the receiver 112 includes a wireless receiver 1121, a CP remover 1122, an FFT unit 1123, and an equalizer 1124, and so on. The wireless receiver 1121, the CP remover 1122, and the FFT unit 1123 of the receiver 112 performs functions inverse to functions of the wireless transmitter 1115, the CP inserter 1114, and the IFFT unit 113 of the transmitter 111. The receiver 112 may further include a demodulator.

An example in which a disclosure of the present specification can be utilized will be described as follows.

### General Description on Device to Which Disclosure of the Present Specification is Applicable

Hereinafter, a device to which the present disclosure is applicable will be described.

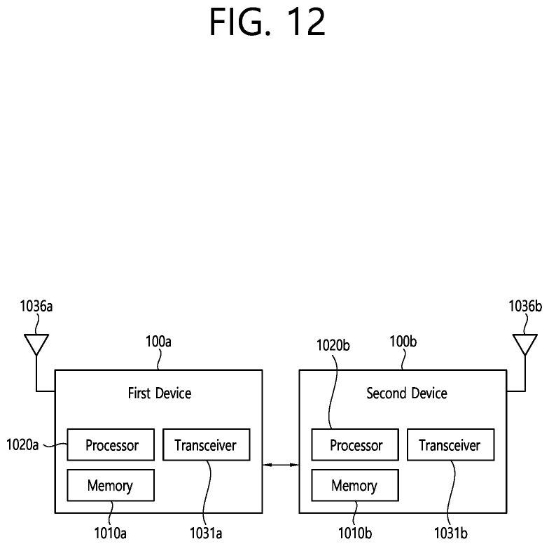

FIG. 12 shows a wireless communication system according to an embodiment.

Referring to FIG. 12, a wireless communication system may include a first device 100a and a second device 100b.

The first device 100a may be a base station, a network node, a transmitting terminal, a receiving terminal, a wireless device, a wireless communication device, a vehicle, a vehicle equipped with self-driving capability, a connected car, a drone (or an unmanned aerial vehicle (UAV)), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or a financial device), a security device, a climate/environment device, a device related to a 5G service, or a device related to a field of the 4th industrial revolution.

The second device 100b may be a base station, a network node, a transmitting terminal, a receiving terminal, a wireless device, a wireless communication device, a vehicle, a vehicle equipped with self-driving capability, a connected car, a drone (or an unmanned aerial vehicle (UAV)), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or a financial device), a security device, a climate/environment device, a device related to a 5G service, or a device related to a field of the 4th industrial revolution.

For example, a terminal may include a mobile phone, a smart phone, a laptop computer, a digital broadcasting terminal, a personal digital assistants (PDA), a portable multimedia player (PMP), a navigation, a slate PC, a table PC, an ultrabook, a wearable device (e.g., a smartwatch, a smart glass, a head mounted display (HMD)), or the like. For example, the HMD may be a display device worn on a head. For example, the HMD may be used to implement VR, AR, or MR.

For example, the drone may be an unmanned aerial vehicle which flies by using a radio control signal. For example, the VR device may include a device for realizing an object, background, or the like of a virtual world. For example, the AR device may include a device for realizing an object or background of a virtual world by connecting with an object or background or the like of a real world. For example, the MR device may include a device for realizing an object or background of a virtual world by merging an object, background, or the like of a real world. For example, the hologram device may include a device for recording and reproducing stereoscopic information to realize a 360-degree stereoscopic image, by utilizing light interference which occurs when two laser beams called holography are met. For example, the public safety device may include an image relay device or an image device or the like which can be worn on a user's body. For example, the MTC device and the IoT device may be devices not requiring direct human intervention or manipulation. For example, the MTC device and the IoT device may include a smart meter, a bending machine, a thermometer, a smart bulb, a door lock, or various sensors. For example, the medical device may be a device used for diagnosing, curing, alleviating, treating, or preventing a disease. For example, the medial device may be a device used for diagnosing, curing, alleviating or ameliorating an injury or disorder. For example, the medial device may be a device used for inspecting, replacing, or modifying a structure or function. For example, the medical device may be a device used for controlling pregnancy. For example, the medical device may include a diagnostic device, a surgical device, a (in vitro) diagnostic device, a hearing aid, or a treatment device. For example, the security device may be a device installed to prevent potential hazards and maintain security. For example, the security device may be a camera, a CCTV, a recorder, or a black box. For example, the Fin-Tech device may be a device capable of providing financial services such as mobile payment. For example, the Fin-tech device may include a payment device or a point of sales (POS). For example, the climate/environmental device may include a device for monitoring or predicting climates/environments.

The first device 100a may include at least one processor such as a processor 1020a, at least one memory such as a memory 1010a, and at least one transceiver such as a transceiver 1031a. The processor 1020a may perform the aforementioned functions, procedures, and/or methods. The processor 1020a may perform one or more protocols. For example, the processor 1020a may perform one or more layers of a radio interface protocol. The memory 1010a may be coupled to the processor 1020a, and may store various types of information and/or commands. The transceiver 1031a may be coupled to the processor 1020a, and may be controlled to transmit/receive a radio signal.

The second device 100b may include at least one processor such as a processor 1020b, at least one memory such as a memory 1010b, and at least one transceiver such as a transceiver 1031b. The processor 1020b may perform the aforementioned functions, procedures, and/or methods. The processor 1020b may perform one or more protocols. For example, the processor 1020b may perform one or more layers of a radio interface protocol. The memory 1010b may be coupled to the processor 1020b, and may store various types of information and/or commands. The transceiver 1031b may be coupled to the processor 1020b, and may be controlled to transmit/receive a radio signal.

The memory 1010a and/or the memory 1010b may be connected internally or externally to the processor 1020a and/or the processor 1020b, respectively, or may be connected to other processors through various techniques such as wired or wireless connections.

The first device 100a and/or the second device 100b may have one or more antennas. For example, an antenna 1036a and/or an antenna 1036b may be configured to transmit/receive a radio signal.

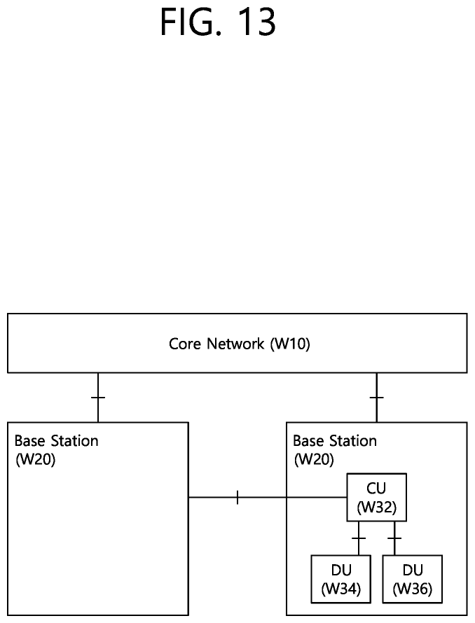

FIG. 13 is a block diagram of a network node according to an embodiment.

In particular, FIG. 13 shows an example of the network node of FIG. 12 in greater detail, when a base station is divided into a central unit (CU) and a distributed unit (DU).

Referring to FIG. 13, base stations W20 and W30 may be connected to a core network W10, and the base station W30 may be connected to the neighboring base station W20. For example, an interface between the base stations W20 and W30 and the core network W10 may be referred to as NG, and an interface between the base station W30 and the neighboring base station W20 may be referred to as Xn.

The base station W30 may be divided into a CU W32 and DUs W34 and W36. That is, the base station W30 may be managed by being separated in a layered manner. The CU W32 may be connected to one or more DUs W34 and W36. For example, an interface between the CU W32 and the DUs W34 and W36 may be referred to as F1. The CU W32 may perform a function of higher layers of the base station, and the DUs W34 and W36 may perform a function of lower layers of the base station. For example, the CU W32 may be a logical node for hosting radio resource control (RRC), service data adaptation protocol (SDAP), and packet data convergence protocol (PDCP) layers of the base station (e.g., gNB), and the DUs W34 and W36 may be a logical node for hosting radio link control (RLC), media access control (MAC), and physical (PHY) layers of the base station. Alternatively, the CU W32 may be a logical node for hosting RRC and PDCP layers of the base station (e.g., en-gNB).

Operations of the DUs W34 and W36 may be partially controlled by the CU W32. One DU W34 or W36 may support one or more cells. One cell may be supported only by one DU W34 or W36. One DU W34 or W36 may be connected to one CU W32, and one DU W34 or W36 may be connected to a plurality of CUs by proper implementation.

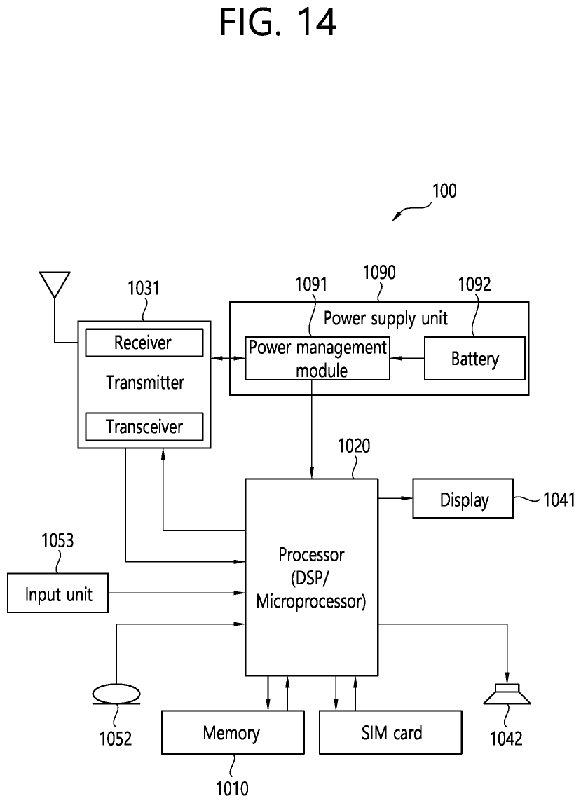

FIG. 14 is a block diagram showing a structure of a terminal according to an embodiment.

In particular, FIG. 14 shows an example of the terminal in greater detail.

A terminal includes a memory 1010, a processor 1020, a transceiver 1031, a power management module 1091, a battery 1092, a display 1041, an input unit 1053, a speaker 1042, a microphone 1052, a subscriber identification module (SIM) card, and one or more antennas.

The processor 1020 may be configured to implement the proposed functions, procedures, and/or methods described in the present specification. Layers of a radio interface protocol may be implemented in the processor 1020. The processor 1020 may include application-specific integrated circuits (ASICs), other chipsets, logic circuits, and/or data processing units. The processor 1020 may be an application processor (AP). The processor 1020 may include at least one of a digital signal processor (DSP), a central processing unit (CPU), a graphics processing unit (GPS), and a modulator and demodulator (modem). An example of the processor 1020 may include an SNAPDRAGON™ series processor manufactured by Qualcomm®, an EXYNOS™ series processor manufactured by Samsung®, an A series processor manufactured by Apple®, a HELIO™ series processor manufactured by MediaTek®, an ATOM™ series processor manufactured by INTEL®, or a corresponding next-generation processor.

The power management module 1091 manages power for the processor 1020 and/or the transceiver 1031. The battery 1092 supplies power to the power management module 1091. The display 1041 outputs a result processed by the processor 1020. The input unit 1053 receives an input to be used by the processor 1020. The input unit 1053 may be displayed on the display 1041. The SIM card is an integrated circuit used to safely store an international mobile subscriber identity (IMSI) used to identify and authenticate a subscriber and a key related thereto in a portable phone and a portable phone device such as a computer. Contacts information may be stored in many SIM cards.

The memory 1010 is operatively coupled to the processor 1020, and stores a variety of information for operating the processor 1020. The memory 1010 may include a read-only memory (ROM), a random access memory (RAM), a flash memory, a memory card, a storage medium, and/or other equivalent storage devices. When the embodiment is implemented in software, the techniques explained in the present specification can be implemented with a module (i.e., procedure, function, etc.) for performing the functions explained in the present specification. The module may be stored in the memory 1010 and may be performed by the processor 1020. The memory 1010 may be implemented inside the processor 1020. Alternatively, the memory 1010 may be implemented outside the processor 1020, and may be coupled to the processor 1020 in a communicable manner by using various well-known means.

The transceiver 1031 is operatively coupled to the processor 1020, and transmits and/or receives a radio signal. The transceiver 1031 includes a transmitter and a receiver. The transceiver 1031 may include a baseband signal for processing a radio frequency signal. The transceiver controls one or more antennas to transmit and/or receive a radio signal. In order to initiate communication, the processor 1020 transfers command information to the transceiver 1031, for example, to transmit a radio signal constituting voice communication data. The antenna serves to transmit and receive a radio signal. When the radio signal is received, the transceiver 1031 may transfer a signal to be processed by the processor 1020, and may convert the signal into a baseband signal. The processed signal may be converted into audible or readable information which is output through the speaker 1042.

The speaker 1042 outputs a result related to a sound processed by the processor 1020. The microphone 1052 receives a sound-related input to be used by the processor 1020.

A user presses (or touches) a button of the input unit 1053 or drives voice (activates voice) by using the microphone 1052 to input command information such as a phone number or the like. The processor 1020 receives the command information, and performs a proper function such as calling the phone number or the like. Operational data may be extracted from the SIM card or the memory 1010. In addition, the processor 1020 may display command information or operational information on the display 1041 for user's recognition and convenience.

### Scenario to Which Disclosure of the Present Specification is Applicable

Hereinafter, a scenario to which the aforementioned disclosures of the present disclosure are applicable will be described.

In the present specification, an always-on PDU session for URLLC having a low latency characteristic may be used for artificial intelligence, robots, autonomous driving, extended reality, etc., in the 5G scenario described below.

### 5G Usage Scenario

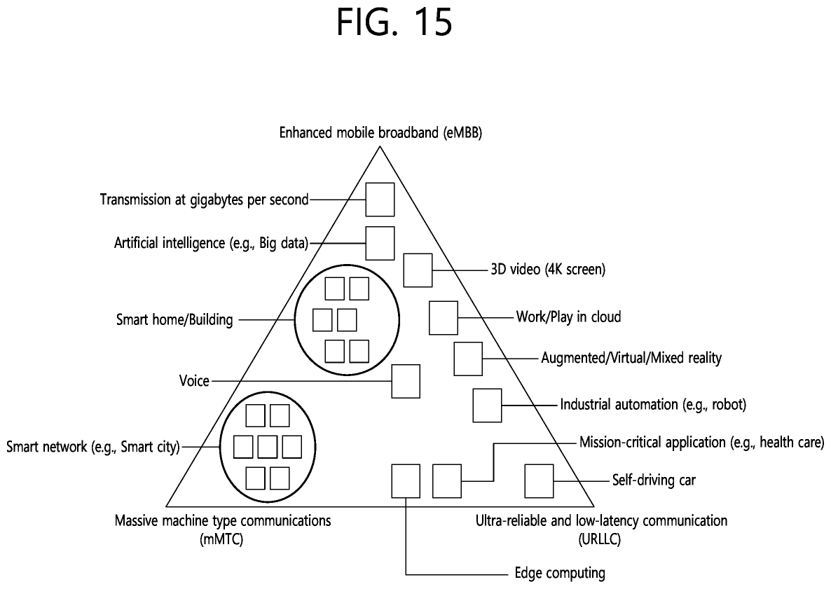

FIG. 15 shows an example of a 5G usage scenario.

The 5G usage scenario of FIG. 15 is for exemplary purposes only, and thus technical features of the present disclosure are also applicable to other 5G usage scenarios.

Referring to FIG. 15, three main requirement areas of 5G includes: (1) an enhanced mobile broadband (eMBB) area; (2) a massive machine type communication (mMTC) area; and (3) an ultra-reliable and low latency communications (URLLC) area. In some usage examples, a plurality of areas may be required for optimization. In other usage examples, only one key performance indicator (KPI) may be focused. The 5G supports these various usage examples in a flexible and reliable manner.

The eMBB focuses on overall improvement of a data rate, latency, user density, mobile broadband access capacity, and coverage. The eMBB aims at a throughput of about 10 Gbps. The eMBB allows to surpass basic mobile Internet access, and covers sufficient interactive tasks, media in a cloud or augmented reality, and entertainment application. Data is one of the core engine for 5G, and it seems that a dedicated voice service can be seen for the first time in the 5G era. In the 5G, it is expected that voice will be simply processed with an application program by using a data connection provided by a communication system. A main reason of an increased traffic amount is an increase in a content size and an increase in the number of applications requiring a high data transfer rate. A streaming service (audio and video), interactive video, and mobile Internet connectivity will be more widely used as more devices are connected to the Internet. These many applications require always-on connectivity to push real-time information and notifications to a user. There is a rapid increase in cloud storage and applications in a mobile communication platform, which is applicable to both work and entertainment. The cloud storage is a special example of driving an increase in an uplink data transfer rate. The 5G is also used for a remote task on the cloud, and requires much lower end-to-end latency to maintain excellent user experience when a tactile interface is used. Taking entertainment for example, cloud games and video streaming are another key element requiring improvement in mobile broadband capability. The entertainment is essential in a smartphone and a tablet anywhere, including a high mobility environment such as a train, a car, and an airplane. Another usage example is augmented reality and information retrieval for entertainment. Herein, the augmented reality requires very low latency and an instantaneous data amount.

The mMTC is designed to enable communication between a plenty of low-cost devices driven by batteries and is intended to support an application such as smart metering, logistics, and field and body sensors. The mMTC aims at about 10-year-lifespan batteries and/or about million devices per square kilometer (1 km2). The mMTC may configure a sensor network by seamlessly connecting an embedded sensor in all sectors, and is one of the most expected 5G usage examples. Potentially, it is predicted that the number of IoT devices will reach 20.4 billion by 2020. A smart network utilizing industrial IoT is one of areas where the 5G plays a key role in enabling smart cities, asset tracking, smart utilities, agriculture, and security infrastructures.

The URLLC allows a device and a machine to communicate with very high reliability, very low latency, and high availability, and thus is identical to communication and control between self-driving vehicles, industrial control, factory automation, mission-critical applications such as remote operations and healthcare, smart grids, and public safety applications. The URLLC aims at a latency of about 1 ms. The URLLC includes a new service which will change the industry through a link with high-reliability/ultra-low latency such as remote control and self-driving vehicles. A level of reliability and latency is essential for smart grid control, industrial automation, robotics, and drone control and adjustment.

Next, a plurality of usage examples included in the triangle of FIG. 15 will be described in greater detail.

In 5G, fiber-to-the-home (FTTH) and cable-based broadband (or DOCSIS) may be compensated as a means of providing a stream rated in the range from hundreds of megabits per second to gigabits per second. This fast speed may be required not only in virtual reality (VR) and augmented reality (AR) but also in transferring TV broadcasting in the resolution of at least 4K (6K, 8K, or higher). VR and AR applications include almost immersive sports events. A specific application may require a special network configuration. For example, in case of the VR game, a game company may have to integrate a core server with an edge network server of an operator in order to minimize latency.

Automotive is expected to become an important new engine for 5G, together with many usages for mobile communications for vehicles. For example, entertainment for a passenger demands high capacity and high mobile broadband at the same time. This is because future users will continue to expect high-quality connectivity regardless of their locations and speeds. Another usage example of the automotive sector is an augmented reality dashboard. Through the augmented reality dashboard, a driver is able to identify an object, in the dark, shown above that the driver is seeing through a windshield. The augmented reality dashboard displays information to be reported to the deriver as to a distance and movement of an object in an overlapping manner. In the future, a radio module will enable communication between vehicles, information exchange between a vehicle and a supported infrastructure, and information exchange between an automotive and another connected device (e.g., a device carried by a pedestrian). The safety system guides an alternative course of action so that the driver can drive more safely, thereby decreasing a risk of accidents. A next step will be a remote control vehicle or a self-driving vehicle. This requires very reliable and very fast communication between different self-driving vehicles and/or between an automotive and an infrastructure. In the future, the self-driving vehicle will perform all driving activities, and the driver will focus only on erroneous traffic which cannot be identified by the vehicle itself. A technical requirement of the self-driving vehicle is ultra-low latency and ultra-high reliability so that traffic safety is increased to a level that cannot be achieved by humans.

A smart city and a smart home, referred to as a smart society, will be embedded in a high-density wireless sensor network as an example of a smart network. A distributed network of an intelligent sensor will identify a condition for cost and energy-efficient maintenance of a city or home. A similar configuration may be performed for each household. A temperature sensor, a window and heating controller, a burglar alarm, and home appliance are all wirelessly connected. Many of these sensors typically require a low data rate, low power, and low cost. For example, however, real-time HD video may be required in a specific-type device for surveillance.

Since consumption and distribution of energy, including heat or gas, are highly dispersed, automated control of a distributed sensor network is required. The smart grid interconnects these sensors by using digital information and communication techniques to collect information and act according to the information. This information may include acts of suppliers and consumers, allowing the smart grid to improve distribution of fuels such as electricity in an efficient, reliable, production sustainable, and automated manner. The smart grid may be regarded as another sensor network with low latency.

The health sector has many applications which can benefit from mobile communication. A communication system may support telemedicine which provides a clinical care in remote locations. This may help to reduce a barrier for a distance, and may improve access to a medical service which cannot be persistently used in a far rural area. This is also used to save lives in a critical care and an emergency situation. A wireless sensor network based on mobile communication may provide remote monitoring and sensors for parameters such as heart rates and blood pressure.

Wireless and mobile communications are becoming gradually important in an industrial application sector. Wiring is expensive in terms of installation and maintenance cost. Therefore, a possibility of replacing a cable with a wireless link that can be reconfigured is an attractive opportunity in many industrial sectors. However, to achieve this, wireless connectivity is required to operate with latency, reliability, and capacity similar to those of a cable, and to be managed in a simplified manner. Low latency and very low error probability are new requirements, which requires 5G connectivity.

Logistics and cargo tracking are an important usage example for mobile communication which enables inventory and package tracking anywhere by using a location-based information system. An example of using logistics and cargo tracking typically requires a low data rate, but requires wide range and reliable location information.

### Artificial Intelligence (AI)

Artificial intelligence refers to a sector that studies artificial intelligence and a methodology for creating it. Machine learning refers to a sector that defines various problems dealt in an artificial intelligent sector and studies a methodology for solving the problems. The machine learning is also defined as an algorithm that improves performance of a task through a steady experience for a certain task.

An artificial neural network (ANN) is a model used in machine learning, and may refer to an overall model having problem-solving ability and consisting of artificial neurons (nodes) constructing a network by combining synapses. The ANN may be defined by a connectivity pattern between neurons of different layers, a leaning processor for updating a model parameter, and an activation unction for generating an output value.

### Robot

A robot may mean a machine which automatically operates or processes a given task according to its own capability. In particular, a robot having a function of performing an operation by recognizing an environment and by autonomously making a decision may be referred to as an intelligent robot.

The robot may be classified for industrial, medical, household, and military purposes depending on the purpose or field of use.

The robot may include a driving unit having an actuator or a motor to perform various physical operations such as moving a robot joint. In addition, a movable robot may include a wheel, a brake, a propeller, and the like in the driving unit, thereby being able to driving on the ground or flying in the air through the driving unit.

### Self-Driving (Autonomous-Driving)

Self-driving means an autonomous-driving technique, and a self-driving vehicle means a vehicle that travels without user's manipulation or with minimum user' manipulation.

For example, the self-driving may include all of a technique for maintaining a lane while driving, a technique for automatically controlling speed such as adaptive cruise control, a technique for automatically travelling along a predetermined route, and a technique for travelling by automatically setting a route when a destination is determined.

The vehicle may include all of a vehicle having only an internal combustion engine, a hybrid vehicle having an internal combustion engine and an electric motor together, and an electric vehicle having only an electric motor, and may include not only an automotive vehicle but also a train, a motorcycle, etc.

In this case, the self-driving vehicle may be regarded as a robot having an autonomous-driving function.

### eXtended Reality (XR)

Extended reality collectively refers to virtual reality (VR), augmented reality (AR), and mixed reality (MR). A VR technique is a computer graphic technique providing real-world objects and backgrounds only as CG images. An AR technique a computer graphic technique providing virtual CG images together on real object images. An MR technique is a computer graphic technique providing virtual objects in the real world in a mixed and combined manner.

The MR technique is similar to the AR technology in a sense that a real object and a virtual object are shown together. However, the AR technology in which the virtual object is used as a complement to the real object differs from the MR technology in which the virtual object and the real object are used in an equal manner.

The XR technique may be applied to a head-mount display (HMD), a head-up display (HUD), a mobile phone, a tablet PC, a laptop, a desktop, TV, a digital signage, etc., and a device to which the XR technique is applied may be referred to as an XR device.

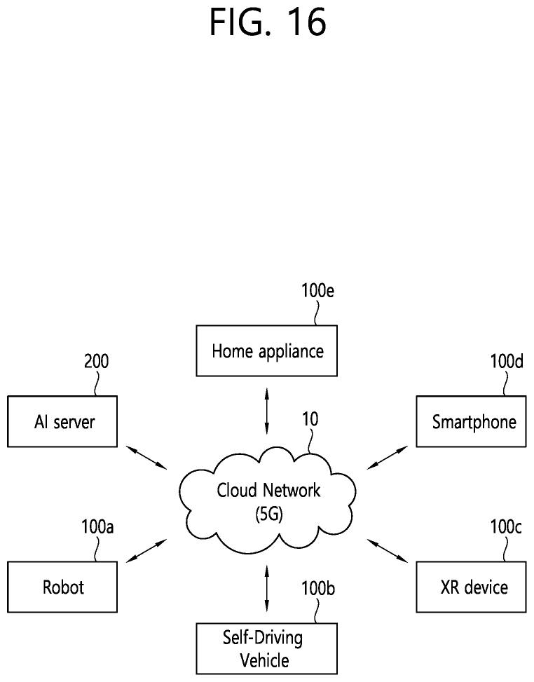

FIG. 16 shows an AI system 1 according to an embodiment.

Referring to FIG. 16, in the AI system 1, at least one of an AI server 200, a robot 100a, a self-driving vehicle 100b, an XR device 100c, a smart phone 100d, and a home appliance 100e is connected to a cloud network 10. Herein, the robot 100a, self-driving vehicle 100b, XR device 100c, smart phone 100d, or home appliance 100e to which the AI technique is applied may be referred to as AI devices 100a to 100e.

The cloud network 10 may mean a network which constructs part of a cloud computing infrastructure or which exists in the cloud computing infrastructure. Herein, the cloud network 10 may be configured by using a 3G network, a 4G or long term evolution (LTE) network, or a 5G network.

That is, each of the devices 100a to 100e and 200 constituting the AI system 1 may be connected to each other through the cloud network 10. In particular, the devices 100a to 100e and 200 may communicate with each other via a base station, but may communicate with each other directly without having to use the base station.

The AI server 200 may include a server which performs AI processing and a server which performs an operation for big data.

The AI server 200 may be connected to at least one of the AI devices constituting the AI system 1, that is, the robot 100a, the self-driving vehicle 100b, the XR device 100c, the smart phone 100d, and the home appliance 100e through the cloud network 10, and may assist at least part of AI processing of the connected AI devices 100a to 100e.

In this case, the AI server 200 may serve to learn an artificial neural network according to a machine learning algorithm on behalf of the AI devices 100a to 100e, and may directly store a learning model or transmit it to the AI devices 100a to 100e.

In this case, the AI server 200 may receive input data from the AI devices 100a to 100e, infer a result value for the input data received using the learning module, and generate a control command or a response based on the inferred result value to transmit it to the AI devices 100a to 100e.

Alternatively, the AI devices 100a to 100e may infer the result value for the input data by using a direct learning model and generate a control command and a response based on the inferred result value.

Hereinafter, various embodiments of the AI devices 100a to 100e to which the aforementioned techniques are applied will be described.

### AI+Robot

The robot 100a may be implemented as a guide robot, a carrying robot, a cleaning robot, a wearable robot, an entertainment robot, a pet robot, an unmanned flying robot, etc., by applying the AI technique.

The robot 100a may include a robot control module for controlling an operation, and the robot control module may mean a software module or a chip implementing the software module as hardware.

The robot 100a may use sensor information acquired from various types of sensors to obtain status information of the robot 100a, to detect (recognize) a surrounding environment and an object, to generate map data, to determine a travel route and a driving plan, to determine a response for user interaction, or to determine an operation.

Herein, the robot 100a may use the sensor information acquired from at least one sensor among a lidar, a radar, and camera to determine a travel path and a driving plan.

The robot 100a may use a leaning model consisting of at least one artificial neural network to perform the aforementioned operations. For example, the robot 100a may use the leaning model to recognize a surrounding environment and an object, and may use the recognized surrounding environment information or object information to determine an operation. Herein, the leaning model may be learned directly from the robot 100a or learned from an external device such as the AI server 200 or the like.

In this case, the robot 100a may generate a result and perform an operation by directly using the learning model. However, it is also possible to perform an operation by transmitting sensor information to the external device such as the AI server 200 or the like and by receiving a result generated based thereon.

The robot 100a may determine the travel path and the driving plan by using at least one of map date, object information detected from sensor information, and object information acquired from an external device, and may control a driving unit so that the robot 100a travels according to the determined travel path and driving plan.

The map data may include object identification information on various objects arranged in a space in which the robot 100a moves. For example, the map data may include object identification information on stationary objects such as walls, doors, or the like and movable objects such as flowerpots, desks, or the like. In addition, the object identification information may include a name, a type, a distance, a location, or the like.

In addition, the robot 100a may control the driving unit on the basis of a user's control/interaction to travel or perform an operation. In this case, the robot 100a may acquire the intention information of an interaction based on a user's action or voice utterance, and may determine a response based on the acquired intention information to perform an operation.

### Combinations of AI, Robot, Autonomous-Driving, and XR

The self-driving vehicle 100b may be implemented as a mobile robot, a vehicle, an unmanned aerial vehicle, or the like, by applying an AI technology.

The XR device 100c may be implemented as a Head-Mount Display (HMD), a Head-Up Display (HUD) equipped in a vehicle, a television, a mobile phone, a smart phone, a computer, a wearable device, a home appliance, a digital signage, a vehicle, a stationary robot, a mobile robot, or the like, by applying the AI technology.

The robot 100a may be implemented as a guide robot, a carrying robot, a cleaning robot, a wearable robot, an entertainment robot, a pet robot, an unmanned flying robot, or the like, by applying the AI technology and an autonomous-driving technology.

The robot 100a may be implemented as a guide robot, a carrying robot, a cleaning robot, a wearable robot, an entertainment robot, a pet robot, an unmanned aerial robot, a drone, or the like, by applying the AI technology and an XR technology.

The self-driving vehicle 100b may be implemented as a mobile robot, a vehicle, an unmanned aerial vehicle, or the like by applying the AI technology and the XR technology.

Although exemplary embodiments of the present disclosure have been described above, the scope of the present disclosure is not limited to the specific embodiments and the present disclosure may be modified, changed, or improved in various ways within the scope of the present disclosure and the category of the claims.

What is claimed is:

1. A method for determining a maximum output power, the method performed by a user equipment (UE) and comprising:
transmitting capability information; and
determining the maximum output power, wherein based on that the capability information does not includes a maximum uplink duty cycle, the maximum output power is determined by using a power management UE maximum power reduction (P-MPR).

2. The method of claim 1, wherein the maximum uplink duty cycle represents a maximum percentage of symbols used for uplink transmission during a given time period

3. The method of claim 1, wherein the P-MPR is applied to satisfy a power exposure requirement.

4. The method of claim 1, further comprising:
transmitting information on the determined maximum output power

5. The method of claim 1, wherein the maximum uplink duty cycle is defined for a frequency range (FR) 2.

6. The method of claim 5, wherein the FR2 includes a n257 band, a n258 band, a n259 band, a n260 band and a n261 band.

7. The method of claim 1, further comprising:
determining the maximum uplink duty cycle; and
performing an uplink transmission based on the determined maximum uplink duty cycle.

8. A user equipment (UE) for determining a maximum output power, comprising:
a transceiver; and
a processor configured to control the transceiver,
wherein the processor transmits capability information and determines the maximum output power,
wherein based on that the capability information does not includes a maximum uplink duty cycle, the maximum output power is determined by using a power management UE maximum power reduction (P-MPR).

9. The UE of claim 8, wherein the maximum uplink duty cycle represents a maximum percentage of symbols used for uplink transmission during a given time period

10. The UE of claim 8, wherein the P-MPR is applied to satisfy a power exposure requirement.

11. The UE of claim 8, wherein the processor transmits information on the determined maximum output power

12. The UE of claim 8, wherein the maximum uplink duty cycle is defined for a frequency range (FR) 2.

13. The UE of claim 12, wherein the FR2 includes a n257 band, a n258 band, a n259 band, a n260 band and a n261 band.

14. The UE of claim 8, wherein the processor determines the maximum uplink duty cycle and performs an uplink transmission based on the determined maximum uplink duty cycle.
